(19) United States
(12) Patent Application Publication
(10) Pub. No.: US 2011/0247367 A1
(43) Pub. Date: Oct. 13, 2011

(54) PRESS BENDING STATION AND METHOD FOR BENDING HEATED GLASS SHEETS

(75) Inventors: Dean M. Nitschke, Maumee, OH (US); David B. Nitschke, Perrysburg, OH (US); Terry A. Bennett, Northwood, OH (US); Roger E. Hummel, Genoa, OH (US)

(73) Assignee: GLASSTECH, INC., Perrysburg, OH (US)

(21) Appl. No.: 12/756,521

(22) Filed: Apr. 8, 2010

(51) Int. Cl. C03B 23/02

(52) U.S. Cl. 65/287

(57) ABSTRACT

A press bending station (12) for heated glass sheets includes a conveyor (36) having a lower support structure (38) and central conveyor assemblies (40ᵣ) with horizontal rollers (41) as well as having lateral outward wheel conveyor assemblies (40_{w}) with wheels 44 and/or laterally outward inclined roller conveyor assemblies (40ᵣ) with inclined rollers (43) for supporting and conveying upwardly formed portions of a preformed heated glass sheet with an upwardly concave shape. Each conveyor assembly has a detachable connection (46) to a drive mechanism (48) of the lower support to provide rotational driving of a roller (41 or 43) or wheel (44) of each conveyor assembly. An actuator (62) provides relative vertical movement that lifts the heated preformed glass sheet received by the conveyor (36) to provide press bending thereof between a lower press ring (52) and an upper press mold (58).

### BACKGROUND OF THE INVENTION

1. Field of the Invention

This invention relates to a heated glass sheet press bending station.

2. Background Art

U.S. Pat. No. 6,543,255 Bennett et al., whose entire disclosure is hereby incorporated by reference, discloses a system for glass sheet press bending which in one embodiment is performed after initial prebending of glass sheets in a heating furnace before conveyance to a press bending station. A lower wheel bed of the system has a lower support mounting wheel assemblies that convey each prebent glass sheet from the heating furnace into the press bending station for the press bending. The wheel assemblies have detachable connections to a drive mechanism of the lower support to provide rotational driving of a wheel of each wheel assembly. An actuator provides relative vertical movement that lifts a heated glass sheet received by the wheel bed to provide press bending thereof between a lower press ring and an upper press mold. Connection and detachment of the wheel assemblies facilitates switching from one production job to the next.

### SUMMARY OF THE INVENTION

An object of the present invention is to provide an improved press bending station for press bending heated glass sheets.

In carrying out the above object, the press bending station of the invention includes a conveyor for conveying preformed upwardly concave heated glass sheets along a direction of conveyance. A plurality of elongated supports extend along the direction of conveyance and are spaced laterally from each other with at least some of the elongated supports each including a continuous drive member. Jacks adjustably position the heights of at least the laterally outermost elongated supports so as to be positionable higher than the elongated supports located centrally laterally between the laterally outermost elongated supports. The conveyor includes a lower bed of conveyor assemblies having conveyor assemblies spaced from each other along the direction of conveyance and including laterally spaced conveyor assemblies that are spaced from each other in a direction transverse to the direction of conveyance, and each conveyor assembly includes a detachable drive connection for mounting thereof on an associated elongated support for rotary driving thereof by its continuous drive member. A plurality of the conveyor assemblies at laterally central locations of the conveyor are spaced from each other along the direction of conveyance and each includes a horizontally extending elongated roller having a round cylindrical outer surface and having a laterally extending axial length that is at least two times the diameter of its round outer surface to facilitate conveyance of the preformed glass sheets while maintaining their shapes. A plurality of the conveyor assemblies are located laterally outward from and on opposite sides of the conveyor assemblies having the horizontally extending elongated rollers to support and convey upwardly formed portions of the preformed glass sheet above the horizontal rollers. A lower press ring of the bending station has a lower position within the lower bed of conveyor assemblies below the preformed glass sheet and is movable upwardly to lift the preformed glass sheet, and the bending station has an upper mold to which the preformed glass sheet is moved by the lower press ring to cooperate therewith in press bending the glass sheet.

In one embodiment of the conveyor, each horizontally extending elongated roller is located at the lateral center of the conveyor.

In another embodiment of the conveyor, at spaced locations along the direction of conveyance a pair of conveyor assemblies are located with the horizontally extending elongated rollers thereof axially aligned with each other on opposite axial sides of the lateral center of the conveyor.

In one construction, the glass sheet press bending station includes a plurality of conveyor assemblies located laterally outward from and on opposite sides of the horizontally extending elongated rollers and having wheels each of which has a round outer surface and an axial length that is less than its diameter, and the round outer surface of each wheel has a curved shape along its axial length to support and convey the upwardly formed portions of the conveyed glass sheet at an elevation above the horizontal rollers.

In an alternate construction, the glass sheet press bending station includes a plurality of conveyor assemblies located laterally outward from and on opposite sides of the horizontally extending elongated rollers and including inclined rollers that are inclined downwardly toward the lateral center of the conveyor, and each inclined roller has a round cylindrical outer surface having an axial length that is greater than its diameter to support and convey upwardly formed portions of the conveyed glass sheet at an elevation above the horizontal rollers. The conveyor assemblies having the inclined elongated rollers each have a bearing/drive coupling for providing rotational driving.

As disclosed, the alternate construction of the glass sheet press bending station includes both: a plurality of conveyor assemblies located laterally outward from and on opposite sides of the horizontally extending elongated rollers and having wheels each of which has a round outer surface and an axial length that is less than its diameter, and with the round outer surface of each wheel having a curved shape along its axial length to support and convey the upwardly formed portions of the conveyed glass sheet at an elevation above the horizontal rollers; and a plurality of conveyor assemblies located laterally outward from and on opposite sides of the horizontally extending elongated rollers and including inclined rollers that are inclined downwardly toward the lateral center of the conveyor with each inclined roller having a round cylindrical outer surface having an axial length that is greater than its diameter to support and convey the upwardly formed portions of the conveyed glass sheet at an elevation above the horizontal rollers.

Each roller includes a round sleeve having opposite axial ends and is made of an aromatic polyamide polymer, with a bearing that rotatable supports one axial end of the round sleeve on one elongated support, and with a bearing/drive coupling that rotatable supports and rotatively drives the other axial end of the round sleeve on another elongated support that is spaced laterally from the one elongated support and that has one of the continuous drive members for rotatively driving the sleeve.

The objects, features and advantages of the present invention are readily apparent from the following detailed description of the preferred embodiments when taken in connection with the accompanying drawings.

### BRIEF DESCRIPTION OF THE DRAWINGS

FIG. 1 is a side elevational view of a glass sheet processing system including a press bending station for press bending performed upwardly concave heated glass sheets in accordance with the present invention.

FIG. 2 is a cross sectional view through the system along the direction of line 2-2 in FIG. 1 adjacent an exit end of a furnace of the system and illustrates horizontal and inclined rolls on which each heated and preformed glass sheet is conveyed for roll forming prior to exiting the furnace in preparation for the press bending.

FIG. 3 is a cross sectional view taken through the system along the direction of line 3-3 in FIG. 1 to illustrate the construction of a press bending station of the system as having a conveyor as well as a lower ring mold and an upper press mold that are movable between the solid and phantom line indicated positions to press bend the initially preformed glass sheet.

FIG. 4 is a side view of the press bending station taken along the direction of line 4-4 in FIG. 3 to further illustrate its construction.

FIG. 5 is perspective view of a conveyor which includes a lower bed of conveyor assemblies for conveying the preformed heated glass sheets into the press bending station.

FIG. 6 is a perspective view of the press bending station.

FIG. 7 is an elevational view of the press bending station taken in the same direction as FIG. 3.

FIG. 8 is a side view taken along the direction of line 8-8 in FIG. 7 to illustrate the construction of the conveyor of the press bending station.

FIG. 9 is a partial sectional view taken along the direction of line 9-9 of FIG. 8 to illustrate the construction of wheel conveyor assemblies of the conveyor and their clamped attachment to an associated elongated support or rail of the conveyor.

FIG. 10 is a sectional view taken through the wheel conveyor assembly along the direction of line 10-10 in FIG. 9 to illustrate its construction and the manner in which a lower drive member through a continuous drive belt drives an upper wheel of the assembly on which the glass sheets are conveyed.

FIG. 11 is a schematic view that illustrates the manner in which the lower drive member of each conveyor assembly is rotatively driven by a continuous drive member of the associated drive mechanism to drive the upper wheel through its associated continuous drive belt.

FIG. 12 is a schematic elevational view taken along the direction of conveyance like FIG. 3 but showing another embodiment of center horizontal rollers of the press station conveyor.

FIG. 13 is a partial top plan view of the press station lower press ring and another construction of the conveyor which includes inclined rollers and wheels on opposite lateral sides of the center horizontal rollers.

FIG. 14 is a partial somewhat perspective view illustrating the FIG. 13 construction of the conveyor.

### DETAILED DESCRIPTION OF THE PREFERRED EMBODIMENTS

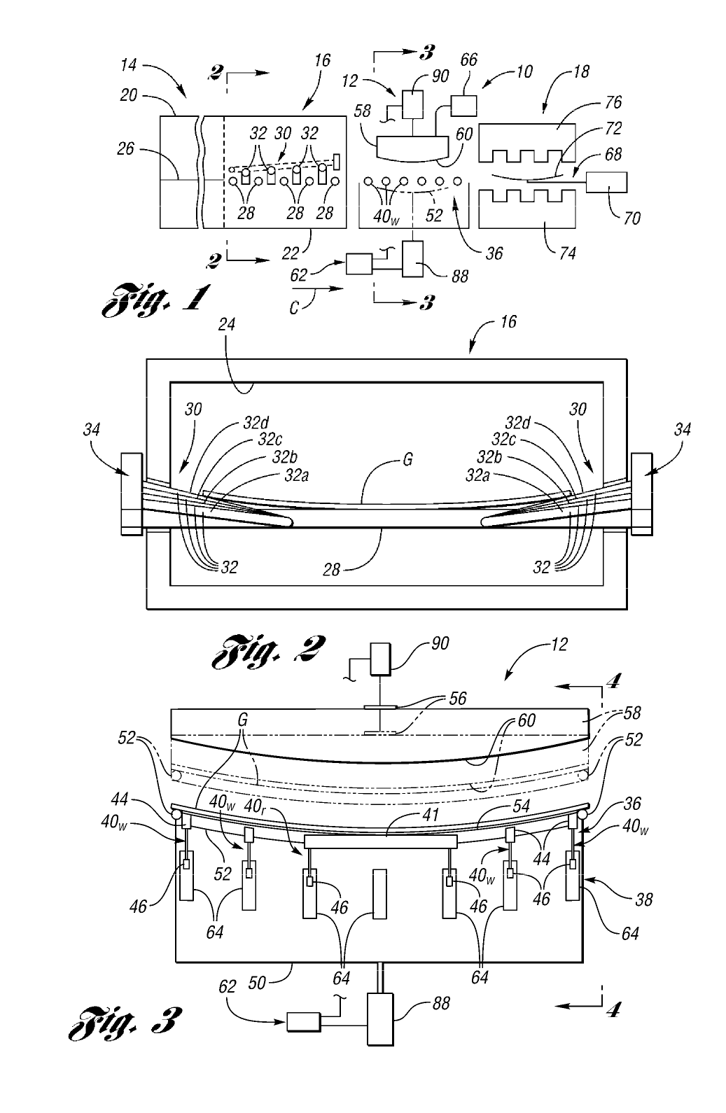

With reference to FIG. 1 of the drawings, a system 10 for processing glass sheets is generally indicated by 10 and includes a press bending station 12 constructed in accordance with the present invention. The system 10 includes a furnace 14 having a roll bending station 16 just upstream along a direction of conveyance C from the press bending station 12. Downstream from the press bending station 12 along the direction of conveyance C, the system 10 is illustrated as including a quench station 18 for providing rapid cooling of a formed glass sheet bent by the roll station 16 and the press station 12 as is hereinafter more fully described. Instead of a quench station, it is also possible for the system to include an annealing station for slowly cooling the formed and bent glass sheet to provide annealing of the glass.

As illustrated by continuing reference to FIG. 1, the furnace 14 has entry and exit ends 20 and 22 and includes a heating chamber 24 (FIG. 2) having a conveyor 26 for conveying glass sheets along the direction of conveyance through the furnace from the entry end to the exit end. The conveyor 26 on which the glass sheets are heated can be either a conventional gas hearth or a roll conveyor on which the glass sheets are conveyed during heating from ambient temperature to a sufficiently high temperature to permit bending.

The furnace exit end 22 includes the roll bending station 16 which is illustrated in FIG. 2 as having horizontally extending conveyor rolls 28 that are rotatively driven and spaced horizontally within the heating chamber along the direction of conveyance extending laterally with respect thereto to support and convey the heated glass sheets. The roll bending station 16 also includes a pair of sets 30 of bending rolls 32, with the bending roll sets 30 spaced laterally with respect to each other within the heating chamber 24 along the direction of conveyance. Each set of bending rolls 30 is supported and rotatively driven by a drive mechanism 34 with the bending rolls at progressively increasing inclinations along the direction of conveyance as illustrated by reference numerals 32ₐ, 32_{b}, 32_{c} and 32_{d} in FIG. 2. The conveyance of each heated glass sheet G along the direction of conveyance in cooperation with the bending rolls 32 provides bending or preforming of the heated glass sheet with an upwardly concave shape along a direction transverse to the direction of conveyance as illustrated in FIG. 2.

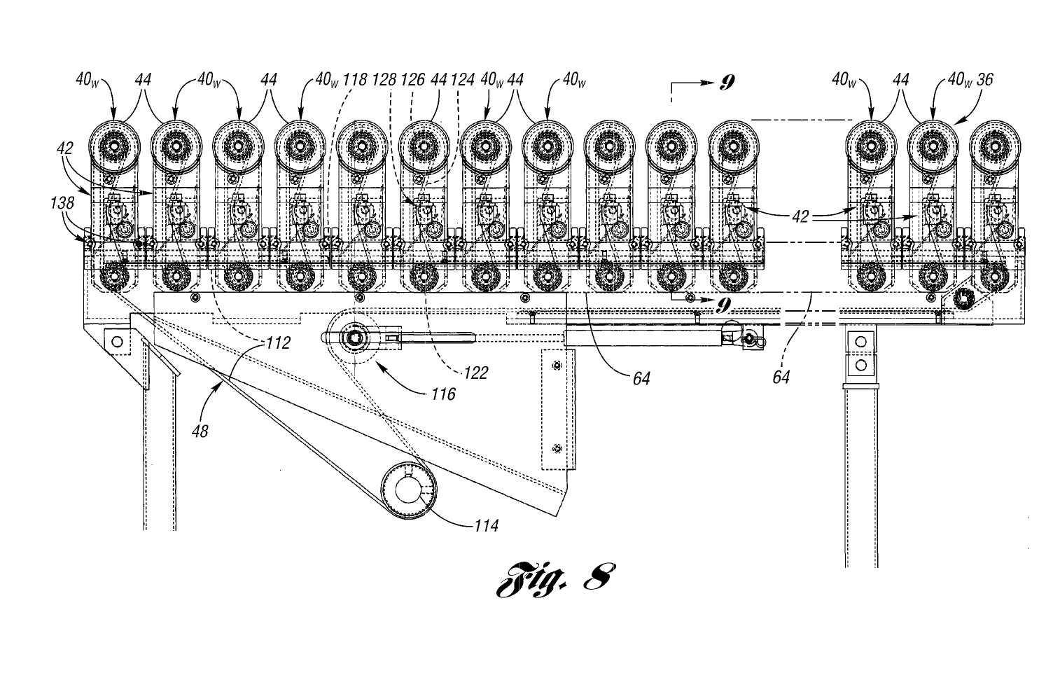

With combined reference to FIGS. 1 and 3-5, the press bending station 12 as previously mentioned is located externally of the furnace 14 downstream from its exit end 22 to receive the roll bent glass sheets from the roll bending station 16. More specifically, the press bending station 12 includes a conveyor 36 for receiving a heated glass sheet to be press bent. The conveyor 36 includes a lower support structure 38 and a bed of a plurality of conveyor assemblies 40ᵣ and 40_{w}. Each conveyor assembly 40ᵣ includes a horizontally extending elongated roller 41 located laterally at a central location of the conveyor. A pair of housings 42 have upper ends including bearings that rotatably support the adjacent ends of the roller 41ᵣ. One of the bearings includes a bearing/coupling for rotatively driving the roller. Each conveyor assembly 40_{w} includes a housing 42 having an upper end including a wheel 44 for supporting and conveying upwardly formed portions of the preformed glass sheet within the press bending station. Each housing 42 has a lower end including a detachable connection 46 for detachably connecting the conveyor assembly to the support structure 38. The one housing 42 supporting and rotatively driving the one end of each roller 41 also has a detachable connection of the associated conveyor assembly to the support structure 38. As is hereinafter more fully described in connection with FIGS. 9-11, a drive mechanism 48 (FIG. 10) provides rotational driving of one end of each roller 41 having the bearing with the coupling or the wheel 44. Upon connection of the associated housing to the support structure 38 as is hereinafter more fully described the roller 41 or wheel 44 is thus rotatively driven.

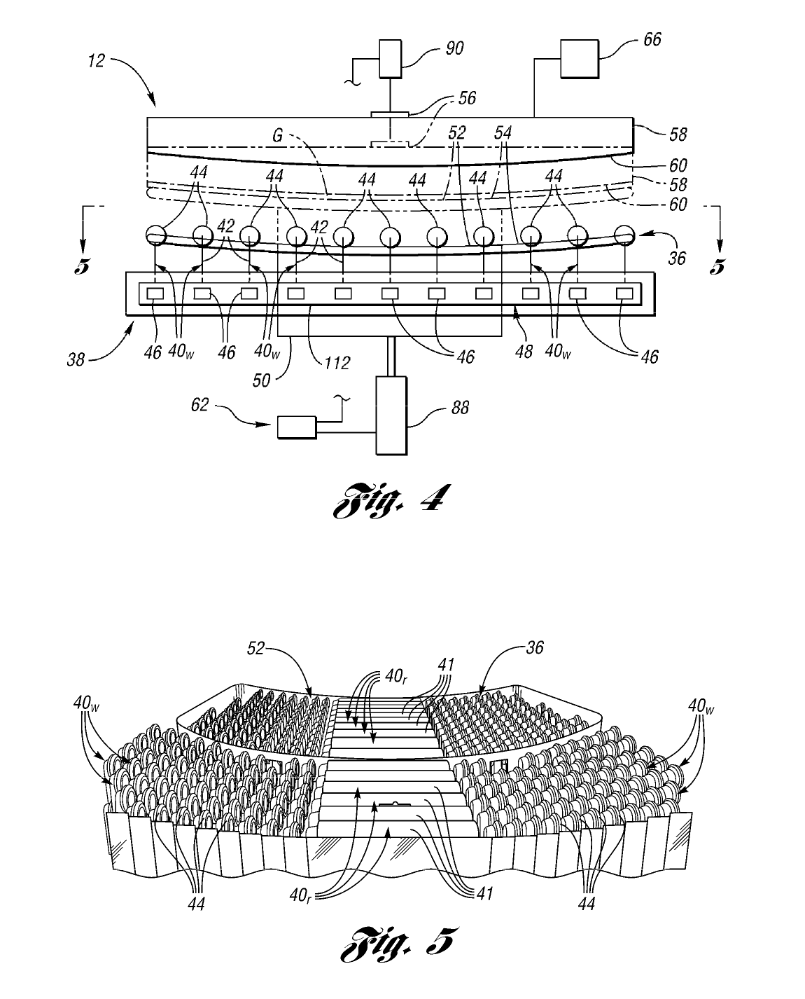

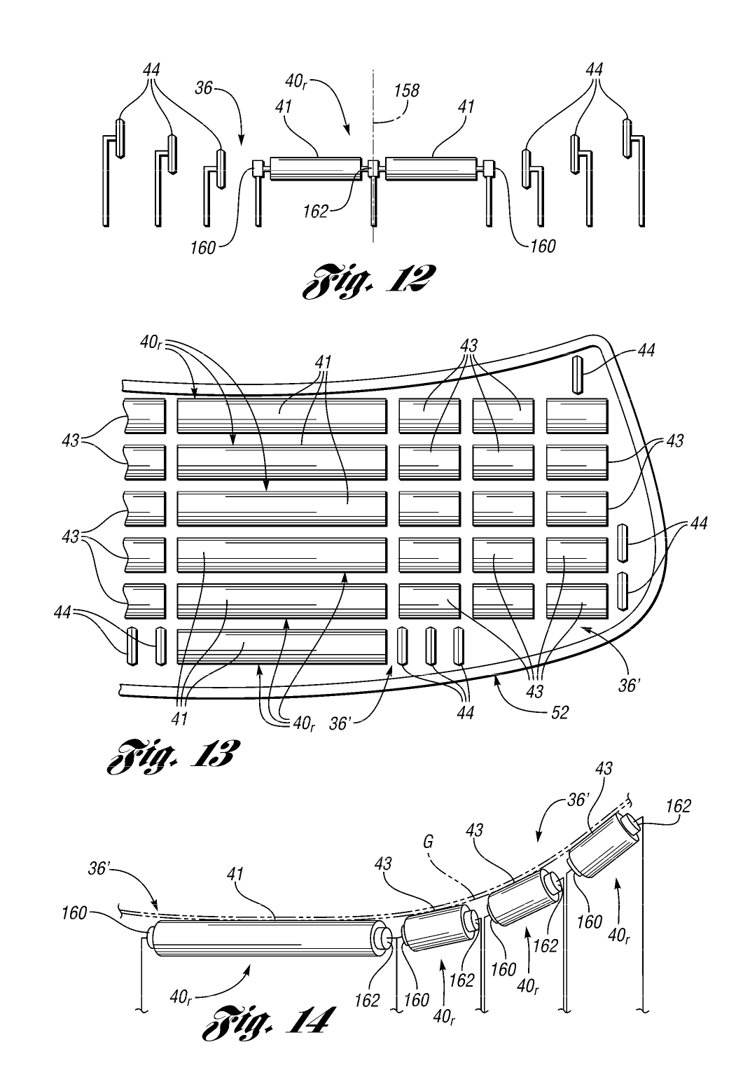

As illustrated in FIG. 3, a lower mount schematically illustrated at 50 supports a lower press ring 52 having a concave curved shape 54 facing upwardly and being received within the conveyor 36 below the upper extremities of the horizontal rollers 41 and the wheels 44 of the conveyor assemblies 40ᵣ and 40_{w} in a ring shape thereof where no conveyor assemblies are located as best illustrated in FIG. 13. As further illustrated in FIG. 3, an upper mount 56 of the press station 12 supports an upper press mold 58 having a downwardly facing curved forming face 60 complementary to the upwardly curved shape 54 of the lower press ring 52.

An actuator collectively indicated by 62 in FIGS. 3 and 4 provides relative vertical movement between the conveyor 36 and the lower press ring 52 and between the lower press ring and the upper press mold 58 to move the heated glass sheet above the wheel bed and into pressing engagement between the lower press ring and the upper press mold to press bend the glass sheet.

The conveyor 36 thus has a curved shape transverse to the direction of conveyance along which the bed of conveyor assemblies receives the heated glass sheet, with the curved shape corresponding to its preformed curved shape provided by the roll bending station 16 illustrated in FIG. 2. More specifically, the support structure 38 of the conveyor 36 includes a plurality of elongated supports or rails 64 that extend along the direction of conveyance and have different elevations as shown in FIG. 3 along a direction transverse to the direction of conveyance to provide the curved shape of the conveyor.

With reference to FIG. 1, the press bending station 12 may have the lower press ring 52 and the forming face 60 of the upper press mold 58 provided with a straight shape along the direction of conveyance C or with a curved shape as shown long that direction in order to provide bending both along and transverse to the direction of conveyance. The upper press mold 58 has its forming face 60 provided with a vacuum from a vacuum source 66 so as to support the bent glass sheet after the press bending. Upon upward movement of the upper press mold 58, a shuttle 68 of the quench station 18 is moved by an actuator 70 to move a quench ring 72 toward the left below the upper press mold 58. Termination of the vacuum provided by the vacuum source 66 may then be accompanied by the supply of pressurized gas to the upper press mold surface 60 to release the glass sheet onto the quench ring 72 and the shuttle actuator 70 then moves the shuttle 68 back toward the right to the position illustrated such that the quench ring 72 and the formed glass sheet thereon are located between lower and upper quench heads 74 and 76 which respectively supply upwardly and downwardly directed quenching gas that rapidly cools the glass sheet to provide toughening thereof that increases its mechanical strength.

It should be appreciated that while the press station illustrated has a quench station, it is also possible for the press station to function without any quench station, such as with annealing as is the case when manufacturing laminated windshields for vehicles.

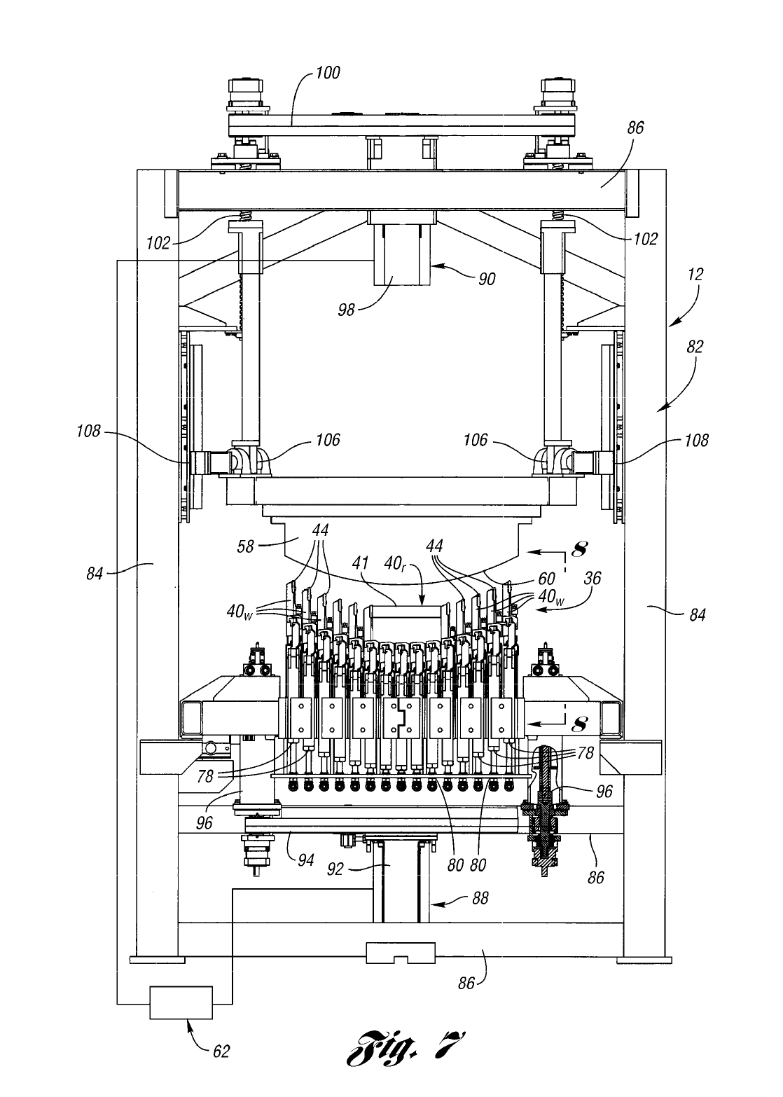

With reference to FIGS. 6 and 7, the press bending station 12 has threaded adjusters 78 that function as jacks to support the rails 64 on which the conveyor assemblies 40ᵣ and 40_{w} are mounted. Threading adjustment of the jacks provides the conveyor 36 with the required curved shape. Furthermore, the threaded adjuster type jacks 78 support the rails 64 on a lower base 80 of the lower support structure 38.

With continuing reference to FIGS. 6 and 7, the press bending station 12 includes a framework collectively indicated by 82 and having vertical posts 84 connected by horizontal beams 86. The vertical actuator 62 previously described in connection with FIG. 3 includes a lower vertical operator 88 for moving the lower press ring 52 vertically relative to the conveyor 36 and also includes an upper vertical operator 90 for moving the upper press mold 58 vertically relative to the framework 84 and the lower press ring. More specifically, the lower vertical operator 88 includes an electric motor 92 whose output drives a belt 94 that operates ball screws 96 that are mounted on lower beams 86 and connected to the lower press ring mount 50 (FIG. 3) to provide the vertical movement of the lower press ring 52 previously described and illustrated in FIG. 3. Furthermore, the upper vertical operator 90 shown in FIGS. 6 and 7 includes an electric motor drive 98 whose output drives a belt 100 that drives ball screws 102 that move a rectangular frame 104 of the upper mount 56 on which the upper press mold 58 is mounted. More specifically, the ball screws 102 are mounted on upper beams 86 and extend downwardly to support slide connections 106 on the corners of the upper press mold mount frame 104. These slide connections 106 are connected to slide guides 108 on the vertical posts 84 such that the ball screw actuation provides guided vertical movement of the upper press mold frame mount 104. The slide connections 106 at diagonally opposite corners are slidable about aligned axes that intersect at a thermally stable center 110 about which the upper press mold 58 expands and contracts upon heating and cooling so as to insure accuracy in the location of the shape about which the bending takes place. Instead of the belt driving of the upper press mold frame mount 104, it is also possible to use four servo motors at the four corners of the press station to provide the upper mold vertical movement.

The press bending station 12 can be supported on the factory floor for movement into position within the glass processing system by air float supports. A roller guide rail may be used to guide the quench station during the movement into position. Air actuated pins received within holes can be utilized to provide positioning, with a center pin received within a round hole at the thermal center of the upper press mold and with a pair of slot shaped holes on opposite sides of the center pin to allow for thermal expansion while ensuring the proper angular alignment about the center pin.

Also, for some production jobs that are repeatedly done intermittently with other jobs, is may be desirable to have dedicated press bending stations for each job and to switch the press bending stations for the job changes.

The drive mechanism 48 of the conveyor 36 as illustrated schematically in FIG. 4 is further illustrated in FIG. 8 as including a continuous drive member 112 on each rail 64. A suitable electric motor drive has an output 114 that drives all of the drive members 112 each of whose tension is controlled by a tension adjuster generally indicated by 116. The drive member 112 extends to the opposite ends of the lower support rails 64 and has an upper drive reach 118 that rotatively drives the wheel assemblies 40 as is hereinafter more fully described.

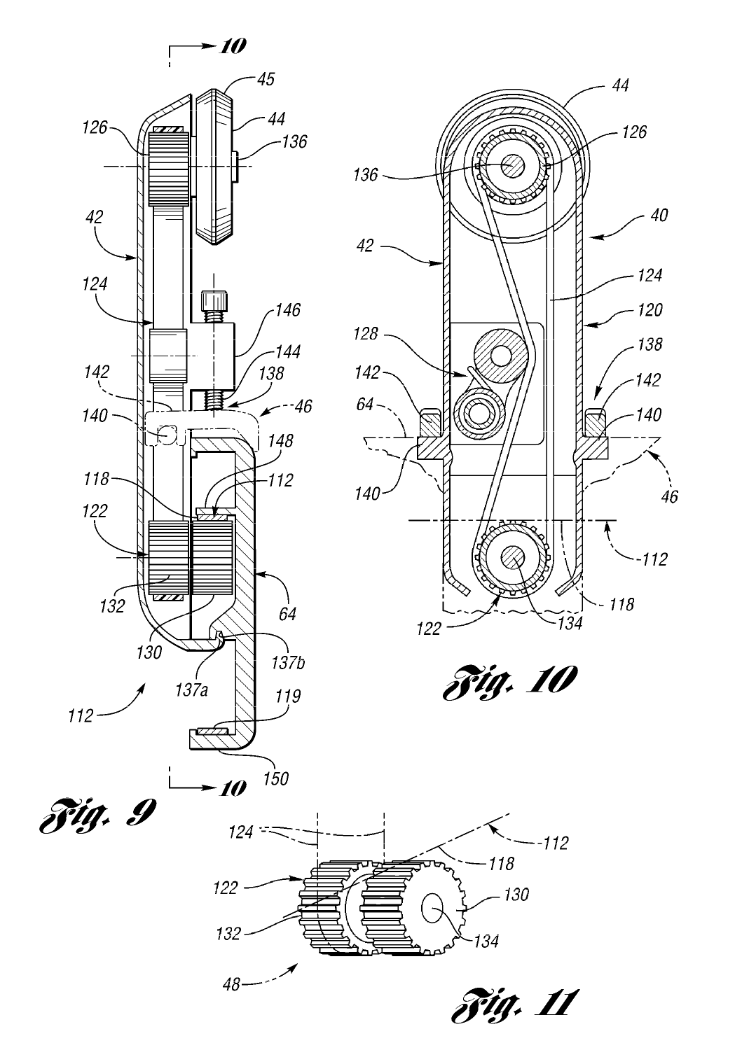

As illustrated by additional reference to FIGS. 9-11, one housing 42 of each roller conveyor assembly 40ᵣ and the housing 42 of each wheel conveyor assembly 40_{w} has a lower drive member 122 rotatably supported on the housing and rotatively driven by the continuous drive member 112 of the associated rail 64 by engagement of the lower drive member with the driving reach 118. A drive belt 124 of each conveyor assembly 40ᵣ and 40_{w} extends around the lower drive member 122 and over an upper drive gear 126 of the associated wheel 44 as shown, or at one end of the associated roller that is either horizontal, or inclined as is hereinafter discussed in connection with FIGS. 13 and 14, to provide rotational driving of the wheel or roller via the impetus provided by the driving reach 118 of drive member 112. A spring biased tension adjuster 128 of each housing provides proper tensioning of the drive belt 124. The drive member 122 as shown in FIG. 11 has a first drive gear 130 that is driven by the driving reach 118 of the drive member 112 and has a second drive gear 132 that drives the drive belt 124. The lower drive member 122 is rotatably mounted by a shaft 134 on a lower end of the housing 120, while the upper drive gear 126 and the wheel 44 are rotatably mounted by a shaft 136 on the upper end of the housing. Each wheel 44 as shown in FIG. 9 has an annular outer surface 45 of a generally curved shape along its axial length for contacting the glass sheet generally at a point regardless of the preformed curved shape of the glass sheet.

As shown in FIGS. 9 and 10, each conveyor assembly housing 42 has its lower end provided with a hook 137a that is hooked into a hook 137b of the rail. Each conveyor housing also includes a clamp 138 that provides clamping thereof to the associated rail 64. More specifically, each side of the housing includes a side projection 140 that is contacted by a hooked end of a clamp member 142 whose other end contacts the upper side of the associated rail 64. The clamp 138 also includes a bolt 144 threaded within a projection 146 of the housing 42 and contacting the clamp member 142 so as to provide the detachable connection of the housing 42 to the rail 64. Upon such connection, the driving reach 118 of the drive member 112 associated with the rail 64 is engaged with the lower drive member 122 below a rail flange 148 to provide the driving connection of the associated roller 41 or the associated wheel 44. The lower return reach 119 of the drive member 112 moves along a lower flange 150 of the rail 64. Unclamping of the clamp 138 and removal of the conveyor assembly thus provides detachment from the drive mechanism.

The detachable driving connection of the conveyor assembly housings 42 also facilitates switching from one production job to another. In doing so, the process begins with the first lower press ring which is received within a first ring shaped void in the conveyor 36 where no conveyor assemblies 40ᵣ or 40w are located. This first lower press ring is removed and another lower press ring is installed within a second ring shaped void that is provided by removing any unnecessary conveyor assemblies 40ᵣ or 40_{w} and attaching the conveyor assemblies necessary to fill the first ring shaped void where it does not overlap with the second ring shaped void. The removal and attachment of the wheel assemblies to and from the rails 64 is provided by the clamping and unclamping of the clamps 138 illustrated in FIGS. 9 and 10 as previously described.

The job switching described above in some instances can utilize the same upper press mold for different ring shapes if there is the same extent of curvature. However, in some instances, it is also necessary to remove the previously used upper press mold and to install a second upper press mold which has a different curvature either transverse to the direction of conveyance and/or along the direction of curvature.

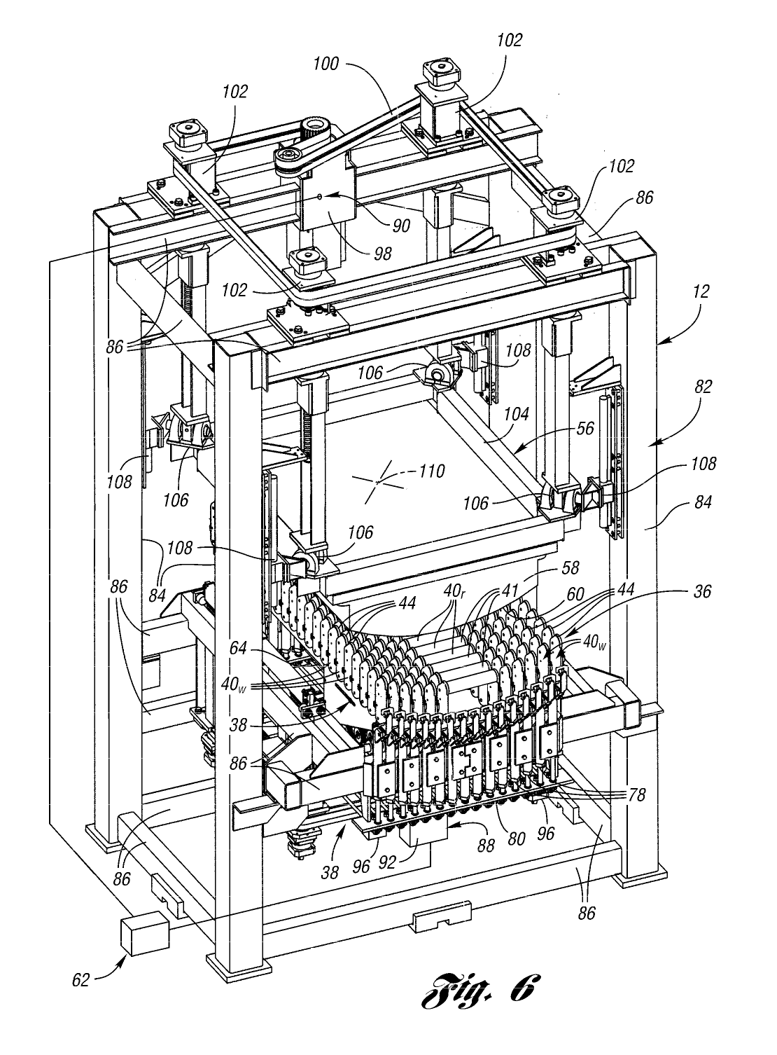

With reference to FIGS. 3 and 5, provision of the central conveyor assemblies 40ᵣ with their rollers 41 supports each conveyed glass sheet G with a generally line contact that reduces the force applied per area to the deformable heated glass sheet. The wheels 44 of the conveyor assemblies 40_{w} support the upwardly raised portions of the preformed glass sheet G at lateral outward locations of the conveyor on opposite lateral sides of the laterally central roller conveyor assemblies 40ᵣ.

As shown in FIG. 3, the roller conveyor assemblies 40ᵣ may have their opposite axial ends supported by spaced rails 64 with the location of one or more rails spanned by the length of the roller without any support therefrom. With such constructions, the intermediate rail or rails are not needed for any conveyor support or driving. However, provision of the rails at such locations provides a more versatile machine which can be utilized to provide conveyor roller or wheel supports for other jobs where such is required. Furthermore, with the roller conveyor assemblies 40ᵣ, only the rail 64 at one end of the associated roller 41 has a bearing/coupling that provides rotational support and driving while the rail at the other end has a bearing that only provides rotational support and, as such, no drive member is needed for such rail. Nevertheless, a drive member can be provided to provide a more versatile construction that can be used for other production jobs where rotational driving as well as support is necessary at that rail.

With reference to FIG. 12, while the previously described embodiment has the roll 41 of a roll conveyor assembly 40ᵣ located at the lateral center 158 of the conveyor, it is also possible to have more than one horizontal roller 41 located on opposite sides of the conveyor lateral center with these rollers in axial alignment with each other and each one driven at one of its ends and rotatively supported at its other end. Thus, the rollers 41 provide the center support for the glass between the laterally outward wheels 44 on each lateral side of the conveyor.

With reference to FIGS. 13 and 14, another embodiment of the conveyor 36′ includes a plurality of roller conveyor assemblies 40ᵣ having inclined rollers 43 that are located on opposite lateral sides of the central horizontal rollers 41 and that are raised with respect to the horizontal rollers to provide distributed support at the upwardly formed locations of the preformed glass sheet G. These inclined rollers 43 like the horizontal rollers 41 have round outer surfaces and have axial lengths that are greater than their diameter and are supported at opposite axial ends with one end providing the rotational driving as previously discussed in connection with the horizontal rollers 41. With this construction having roll ends adjacent each other, adjacent ends of adjacent rollers can be supported by the same longitudinal rail and may also be rotatively driven thereby or by another rail that supports the other end of the inclined roller. Furthermore, this construction as shown in FIG. 13 also has the wheel conveyor assemblies with the wheels 44 at appropriate locations to fill in the smaller voids within the press ring 52 where rollers will not fit.

As shown in FIG. 14, each horizontal roller 41, like the horizontal rollers of the embodiments of FIGS. 1-12, and each inclined roller 43 has one end supported by a bearing 160 and another end supported and rotatively driven by a bearing/coupling 162.

Each of the horizontal and inclined rollers 41, 43 has a round sleeve with opposite axial ends and is made of an aromatic polyamide fiber. As previously described one end of each roller is supported and rotatively driven by a bearing/coupling of one of the conveyor housings 42 and the other end is rotatively supported by a suitable bearing without any rotational driving.

While the preferred embodiments for practicing the invention have been described in detail, those familiar with the art to which this invention relates will recognize various alternative modes and ways of practicing the invention as defined by the following claims.

What is claimed is:

1. A glass sheet press bending station comprising:
a conveyor for conveying preformed upwardly concave heated glass sheets along a direction of conveyance;
a plurality of elongated supports extending along the direction of conveyance and spaced laterally from each other, at least some of the elongated supports each including a continuous drive member, and jacks for adjustable positioning the heights of at least the laterally outermost elongated supports so as to be positionable higher than the elongated supports located centrally laterally between the laterally outermost elongated supports;
the conveyor including a lower bed of conveyor assemblies having conveyor assemblies spaced from each other along the direction of conveyance and including laterally spaced conveyor assemblies that are spaced from each other in a direction transverse to the direction of conveyance, and each conveyor assembly including a detachable drive connection for mounting thereof on an associated elongated support for rotary driving thereof by the continuous drive member thereof;
a plurality of the conveyor assemblies at laterally central locations of the conveyor being spaced from each other along the direction of conveyance and each including a horizontally extending elongated roller having a round cylindrical outer surface and having a laterally extending axial length that is at least two times the diameter of its round outer surface to facilitate conveyance of the preformed glass sheets while maintaining their shapes;
a plurality of the conveyor assemblies being located laterally outward from and on opposite sides of the conveyor assemblies having the horizontally extending elongated rollers to support and convey upwardly formed portions of the preformed glass sheet above the horizontal rollers;
a lower press ring within the lower bed of conveyor assemblies below the preformed glass sheet and being movable upwardly to lift the preformed glass sheet; and
an upper mold to which the preformed glass sheet is moved by the lower press ring to cooperate therewith in press bending the glass sheet.

2. A glass sheet press bending station as in claim 1 wherein each horizontally extending elongated roller is located at the lateral center of the conveyor.

3. A glass sheet press bending station as in claim 1 which at spaced locations along the direction of conveyance a pair of conveyor assemblies are located with the horizontally extending elongated rollers thereof axially aligned with each other on opposite axial sides of the lateral center of the conveyor.

4. A glass sheet press bending station as in claim 1 which includes a plurality of conveyor assemblies located laterally outward from and on opposite sides of the horizontally extending elongated rollers and having wheels each of which has a round outer surface and an axial length that is less than its diameter, and the round outer surface of each wheel having a curved shape along its axial length to support and convey the upwardly formed portions of the conveyed glass sheet at an elevation above the horizontal rollers.

5. A glass sheet press bending station as in claim 1 further including a plurality of conveyor assemblies located laterally outward from and on opposite sides of the horizontally extending elongated rollers and including inclined rollers that are inclined downwardly toward the lateral center of the conveyor, and each inclined roller having a round cylindrical outer surface having an axial length that is greater than its diameter to support and convey upwardly formed portions of the conveyed glass sheet at an elevation above the horizontal rollers.

6. A glass sheet press bending station as in claim 5 wherein the conveyor assemblies having the inclined rollers have a bearing/drive coupling for providing rotational driving.

7. A glass sheet press bending station as in claim 1 which includes:
a plurality of conveyor assemblies located laterally outward from and on opposite sides of the horizontally extending elongated rollers and having wheels each of which has a round outer surface and an axial length that is less than its diameter, and the round outer surface of each wheel having a curved shape along its axial length to support and convey the upwardly formed portions of the conveyed glass sheet at an elevation above the horizontal rollers; and
a plurality of conveyor assemblies located laterally outward from and on opposite sides of the horizontally extending elongated rollers and including inclined rollers that are inclined downwardly toward the lateral center of the conveyor with each inclined roller having a round cylindrical outer surface having an axial length that is greater than its diameter to support and convey the upwardly formed portions of the conveyed glass sheet at an elevation above the horizontal rollers.

8. A glass sheet press bending station as in claim 1 wherein each elongated roller includes a round sleeve having opposite axial ends and being made of an aromatic polyamide polymer, a bearing that rotatable supports one axial end of the round sleeve on one elongated support, and a bearing/drive coupling that rotatable supports the other axial end of the round sleeve on another elongated support that is spaced laterally from the one elongated support and that has one of the continuous drive members for rotatively driving the sleeve.

9. A glass sheet press bending station comprising:
a conveyor for conveying preformed upwardly concave heated glass sheets along a direction of conveyance;
a plurality of elongated supports extending along the direction of conveyance and spaced laterally from each other, at least some of the elongated supports each including a continuous drive member, and jacks for adjustable positioning the heights of at least the laterally outermost elongated supports so as to be positionable higher than the elongated supports located centrally laterally between the laterally outermost elongated supports;
the conveyor including a lower bed of conveyor assemblies having conveyor assemblies spaced from each other along the direction of conveyance and including laterally spaced conveyor assemblies that are spaced from each other in a direction transverse to the direction of conveyance, and each conveyor assembly including a detachable drive connection for mounting thereof on an associated elongated support for rotary driving thereof by the continuous drive member thereof;
a plurality of the conveyor assemblies at laterally central locations of the conveyor being spaced from each other along the direction of conveyance and each including a horizontally extending elongated roller having a round cylindrical outer surface and having a laterally extending axial length that is at least two times the diameter of its round outer surface to facilitate conveyance of the preformed glass sheets while maintaining their shapes;
a plurality of the conveyor assemblies located laterally outward from and on opposite sides of the conveyor assemblies and having wheels each of which has a round outer surface and an axial length that is less than its diameter, and the round outer surface of each wheel having a curved shape along its axial length to support and convey upwardly formed portions of the conveyed glass sheet at an elevation above the horizontal rollers;
a lower press ring within the lower bed of conveyor assemblies below the preformed glass sheet and being movable upwardly to lift the preformed glass sheet; and
an upper mold to which the preformed glass sheet is moved by the lower press ring to cooperate therewith in press bending the glass sheet.

10. A glass sheet press bending station comprising:
a conveyor for conveying preformed upwardly concave heated glass sheets along a direction of conveyance;
a plurality of elongated supports extending along the direction of conveyance and spaced laterally from each other, at least some of the elongated supports each including a continuous drive member, and jacks for adjustable positioning the heights of at least the laterally outermost elongated supports so as to be positionable higher than the elongated supports located centrally laterally between the laterally outermost elongated supports;
the conveyor including a lower bed of conveyor assemblies having conveyor assemblies spaced from each other along the direction of conveyance and including laterally spaced conveyor assemblies that are spaced from each other in a direction transverse to the direction of conveyance, and each conveyor assembly including a detachable drive connection for mounting thereof on an associated elongated support for rotary driving thereof by the continuous drive member thereof;
a plurality of the conveyor assemblies at laterally central locations of the conveyor being spaced from each other along the direction of conveyance and each including a horizontally extending elongated roller having a round cylindrical outer surface and having a laterally extending axial length that is at least two times the diameter of its round outer surface to facilitate conveyance of the preformed glass sheets while maintaining their shapes;
a plurality of conveyor assemblies located laterally outward from and on opposite sides of the horizontally extending elongated rollers and including inclined rollers that are inclined downwardly toward the lateral center of the conveyor, and each inclined roller having a round cylindrical outer surface having an axial length that is greater than its diameter to support and convey upwardly formed portions of the conveyed glass sheet at an elevation above the horizontal rollers;
a lower press ring within the lower bed of conveyor assemblies below the preformed glass sheet and being movable upwardly to lift the preformed glass sheet; and
an upper mold to which the preformed glass sheet is moved by the lower press ring to cooperate therewith in press bending the glass sheet.

11. A glass sheet press bending station comprising:
a conveyor for conveying preformed upwardly concave heated glass sheets along a direction of conveyance;
a plurality of elongated supports extending along the direction of conveyance and spaced laterally from each other, at least some of the elongated supports each including a continuous drive member, and jacks for adjustable positioning the heights of at least the laterally outermost elongated supports so as to be positionable higher than the elongated supports located centrally laterally between the laterally outermost elongated supports;
the conveyor including a lower bed of conveyor assemblies having conveyor assemblies spaced from each other along the direction of conveyance and including laterally spaced conveyor assemblies that are spaced from each other in a direction transverse to the direction of conveyance, and each conveyor assembly including a detachable drive connection for mounting thereof on an associated elongated support for rotary driving thereof by the continuous drive member thereof;
a plurality of the conveyor assemblies at laterally central locations of the conveyor being spaced from each other along the direction of conveyance and each including a horizontally extending elongated roller having a round cylindrical outer surface and having a laterally extending axial length that is at least two times the diameter of its round outer surface to facilitate conveyance of the preformed glass sheets while maintaining their shapes;
a plurality of the conveyor assemblies located laterally outward from and on opposite sides of the horizontally extending elongated rollers having wheels each of which has a round outer surface and an axial length that is less than its diameter, and the round outer surface of reach wheel having a curved shape along its axial length to support and convey the upwardly formed portions of the conveyed glass sheet at an elevation above the horizontal rollers; and
a plurality of conveyor assemblies located laterally outward from and on opposite sides of the horizontally extending elongated rollers and including inclined rollers that are inclined downwardly toward the lateral center of the conveyor with each inclined roller having a round cylindrical outer surface having an axial length that is greater than its diameter to support and convey the upwardly formed portions of the conveyed glass sheet at an elevation above the elongated horizontal rollers;
a lower press ring within the lower bed of conveyor assemblies below the preformed glass sheet and being movable upwardly to lift the preformed glass sheet; and
an upper mold to which the preformed glass sheet is moved by the lower press ring to cooperate therewith in press bending the glass sheet.
